(19) United States
(12) Patent Application Publication
(10) Pub. No.: US 2005/0248819 A1
(43) Pub. Date: Nov. 10, 2005

(54) Wavelength stabilized lasers with feedback from multiplexed volume holograms feedback

(76) Inventors: Art Hymel, Little Rock, AR (US); Christophe Moser, Pasadena, CA (US)

Correspondence Address: BROWN RAYSMAN MILLSTEIN FELDER & STEINER, LLP, 1880 CENTURY PARK EAST, 12TH FLOOR, LOS ANGELES, CA, 90067, US

(21) Appl. No.: 11/090,720

(22) Filed: Mar. 25, 2005

Related U.S. Application Data
(60) Provisional application No. 60/556,811, filed on Mar. 26, 2004.

(51) Int. Cl. G02B 5/32

(52) U.S. Cl. 359/15; 359/19

(57) ABSTRACT

A laser utilizes feedback from a multiplexed volume holographic grating (VHG) as a stand alone element or integrated in a collimating lens as a wavelength standard to lock the laser output wavelength to its desired value. This feedback is optical, wherein a volume hologram reflection grating is used to generate optical feedback into the laser gain region. The multiplexed VHG can exhibit a variety of spectral bandwidth as a result of coherent superposition of the multiplexed gratings or the multiplexed VHG can replace individual VHGs that are used with several wavelength specific lasers.

### RELATED APPLICATION

The applicant claims priority to provisional patent application No. 60/556,811 filed Mar. 26, 2004.

### BACKGROUND OF THE INVENTION

1. Field of the Invention

The present invention relates to the field of spectral and spatial control of laser output with the use of volume holographic gratings.

Portions of the disclosure of this patent document contain material that is subject to copyright protection. The copyright owner has no objection to the facsimile reproduction by anyone of the patent document or the patent disclosure as it appears in the Patent and Trademark Office file or records, but otherwise reserves all copyright rights whatsoever.

2. Background Art

Volume hologram reflection gratings have been shown to be an extremely accurate and temperature-stable means of filtering a narrow passband of light from a broadband spectrum. This technology has been demonstrated in practical applications where narrow full-width-at-half-maximum (FWHM) passbands are required.

Photorefractive materials, such as LiNbO₃ crystals and certain types of polymers and glasses, have been shown to be effective media for storing volume holographic gratings such as for optical filters or holographic optical memories with high diffraction efficiency and storage density. Volume holographic gratings have been used successfully to stabilize, reduce the linewidth and lock the wavelength of semiconductor laser diodes (“Single mode Operation of 1.55 um semiconductor lasers using a volume holographic grating”, Electronics Letters, 21, 15, 1985; U.S. Pat. No. 5,691,989; “Improvement of the spatial beam quality of laser sources with an intracavity Bragg grating”, Optics Letters, 28,4, 2003; and “Wavelength Stabilization and spectrum narrowing of high Power multimode laser diodes and arrays by use of Volume Bragg Gratings”, Optics Letters, 29, 16, 2004).

FIG. 1 depicts a conventional approach to laser wavelength stabilization of a laser diode bar with a volume holographic grating (VHG). The emitters 101, 102, and 103 of the laser diode bar 100 are collimated in the fast axis with a cylindrical lens 110. The VHG 120 disposed after the cylindrical lens contains only one grating. FIG. 2 shows the same approach but with the collimating lens and VHG integrated a single integrated element. The emitters 201, 202, and 203 of the laser diode bar 200 are collimated in the fast axis with the VHG 210 which is also the wavelength selective element.

A typical spectral response of a multimode broad area diode laser stabilized with a VHG is shown in FIG. 3. The smaller peak just above 782 nm represents the free running laser while the narrow peak at 785 nm represents the stabilized laser using prior art techniques described above.

### SUMMARY OF THE INVENTION

A laser utilizing feedback from a multiplexed volume holographic grating is described. In one embodiment, the feedback is optical, wherein a multiplexed volume hologram reflection grating, with either a flat surface or with a curved surface to act as a collimating lens, is used to generate optical feedback at multiple wavelengths into the laser gain region. In one embodiment, the volume holographic grating consists of planar or curved surfaces of constant refractive index embedded throughout the volume of a collimating lens element containing multiple distinct VHGs with non-overlapping spectra. In another embodiment, the multiplexed VHGs are spectrally overlapping to create a filter response that is the result of coherent superposition of the multiplexed gratings.

### BRIEF DESCRIPTION OF THE DRAWINGS

These and other features, aspects and advantages of the present invention will become better understood with regard to the following description, appended claims and accompanying drawings where:

FIG. 1 is a schematic diagram of a prior art method of using a volume holographic grating to wavelength stabilize a laser diode bar.

FIG. 2 illustrates a prior art method of using a volume holographic grating both as a lens and wavelength selective element to wavelength stabilize a laser diode bar.

FIG. 3 is a prior art example of a wavelength stabilized multimode broad area laser diode.

FIG. 4 is an example of the spectral response of 4 multiplexed VHGs with non-overlapping individual spectral responses.

FIG. 5 illustrates examples of the spectral response of multiplexed VHGs with overlapping individual spectral responses.

FIG. 6 is a schematic diagram illustrating the use of a multiplexed volume holographic grating to wavelength stabilize a laser diode bar.

FIG. 7A is a second schematic diagram illustrating the use of a multiplexed volume holographic grating to wavelength stabilize a laser diode bar.

FIG. 7B is a perspective view of the element of FIG. 7A

FIG. 8A is a schematic diagram illustrating the use of a multiplexed volume holographic grating to wavelength stabilize a laser diode bar.

FIG. 8B is a perspective view of the element of FIG. 8A.

FIG. 9 is a schematic diagram illustrating an embodiment for recording a continuously spatially varying grating period in a VHG.

FIG. 10 is a schematic diagram illustrating another embodiment for recording a continuously spatially variable grating period in a VHG.

FIG. 11 shows an illustration of a cylindrical lens with integrated VHG.

FIG. 12 shows an illustration of a D-lens and an aspheric cylindrical lens.

FIG. 13 shows an illustration of a spherical lens.

FIG. 14 shows an illustration of laser diode with single mode or multimode operation.

FIG. 15 shows an array of three diode lasers.

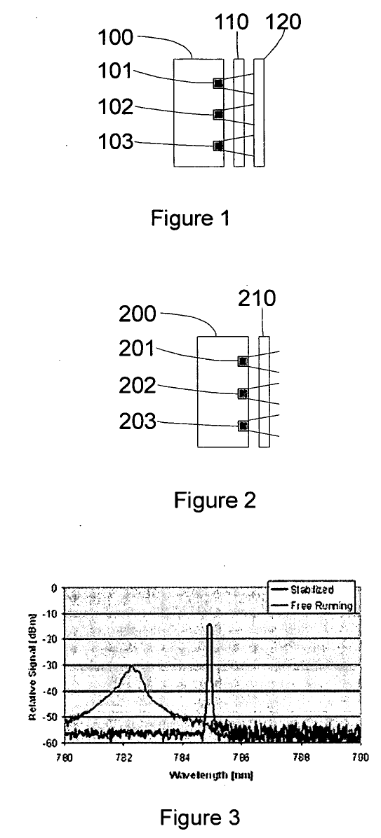

### DETAILED DESCRIPTION OF THE INVENTION

The embodiments of the present invention are a method of and an apparatus for combining the multiplexing and optical feedback for an application using a single holographic element for multiple lasers. In the following description, numerous specific details are set forth to provide a more thorough description of embodiments of the invention. It will be apparent, however, to one skilled in the art, that the embodiments of the present invention may be practiced without these specific details. In other instances, well known features have not been described in detail so as not to obscure the invention.

Volume holographic gratings have been shown to have the property of multiplexing many gratings with different spectral responses in the same volume (“Angle And Space Multiplexed Holographic Storage Using The 90-Degrees Geometry” Opt Commun 117, (1-2), 1995; “Cross-Talk For Angle-Multiplexed And Wavelength-Multiplexed Image Plane Holograms” Opt Lett 19 (21), 1994; “Folded shift multiplexing”, OPT LETT 28 (11), 2003; and “Holographic multiplexing in photorefractive polymers”, OPT COMMUN 185, 2000).

In solid state laser pumping applications, there exist a few discrete wavelengths, including, for example, but not limited to, 795 nm, 808 nm, 880 nm, 905 nm, 915 nm, 940 nm, 976 nm, 985 nm, 1530 nm, and 1850 nm. In one embodiment, a volume holographic grating component containing a plurality of wavelengths from the list above or any other wavelength is used with optical feedback to stabilize a laser. In operation, the grating wavelength matching the laser wavelength effectively reflects the light back into the laser which provides the optical feedback necessary to lock the wavelength of the laser to that of the corresponding grating wavelength.

In some circumstances, it is desirable to have a volume holographic grating element with more than one grating for the purpose of modifying its spectral response. The bandwidth of the filter is determined by its thickness for non-apodized gratings. When multiple gratings are multiplexed with the correct phase, the resulting bandwidth can be wider than the bandwidth given by the matetial's thickness and therefore in situations where thickness is a constraint for packaging reasons for example, it is desirable to modify the natural spectral bandwidth of the volume holographic grating. The multiplexed gratings have individually overlapping spectral responses that coherently interfere to form the resulting filter response.

The multiplexed volume holographic gratings can either be dimensionally flat or curved as described in U.S. patent application Ser. No. ______ filed ______ based on provisional patent application 60/558,212 filed on Mar. 30, 2004 entitled “System And Methods For Refractive And Diffractive Volume Holographic Elements” and assigned to the assignee of the present invention and incorporated by reference herein.

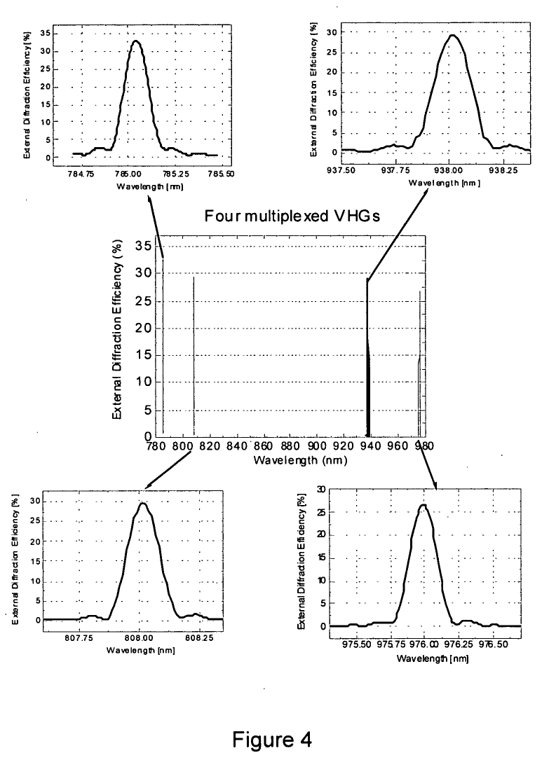

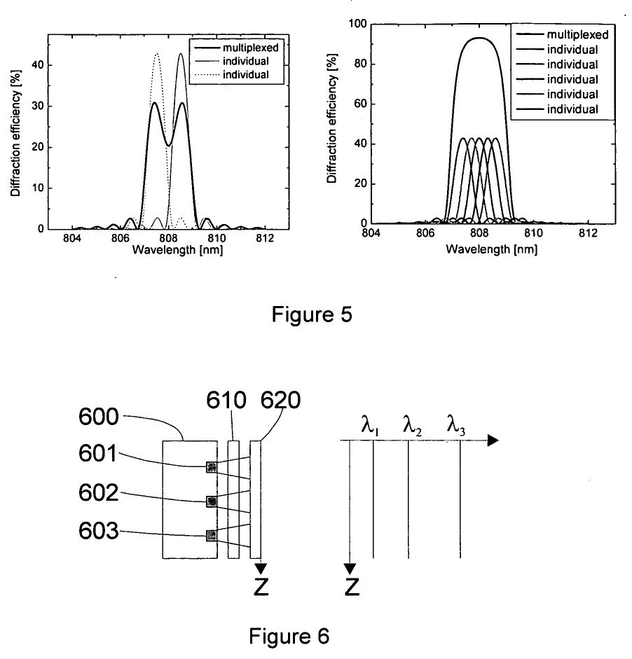

FIGS. 4 and 5 illustrate spectral response for two types of multiplexed elements, non-overlapping and overlapping. FIG. 4 illustrates the spectral response of a multiplexed VHG element with four wavelengths: 785 nm, 808 nm, 938 nm, 976 nm 110 that are non-overlapping. When a laser is projected through the element, it is stabilized by the wavelength nearest its wavelength, within some range. For example, the upper left graph shows an element wavelength centered approximately around 785 nm. A laser in the range of 785 plus or minus 6 or 7 nm will be locked to this wavelength.

FIGS. 5A and 5B illustrates the spectral response of a multiplexed VHG element with overlapping individual spectral responses. FIG. 5A shows the spectral response for a multiplexed element having two overlapping individual wavelengths. The expected response of the individual wavelengths are represented as dotted lines while the spectral response of the multiplexed element is shown as a bold line. An advantage is a broader band of capture than an individual element would provide. FIG. 5B shows four overlapping wavelengths with the multiplexed effect (largest response curve) also providing a broader range of capture frequencies of an input laser. These figures reveal that the bandwidth of the coherent superposition of the multiple filters give rise to a broader spectral response that that obtained from a single filter VHG.

Examples of the use of the multiplexed VHGs to wavelength stabilize laser diodes are shown in FIGS. 6, 7, and 8. FIG. 6 shows a schematic for wavelength stabilizing a multimode or single diode bar 600 with collimating optics 610 and a multiplexed VHG 620. The output of the lasers 601, 602, and 603 of the diode bar are projected through the collimating optics 610 to the multiplexed VHG 620. A portion of the beam is reflected back to the diode by the VHG and locks the wavelength of the laser to the appropriate wavelength. In one embodiment, the multiplexed VHG has a spatially non-varying wavelength across its length. This is represented by the wavelengths lambda 1, 2 and 3 shown as constant along the Z axis of the VHG element.

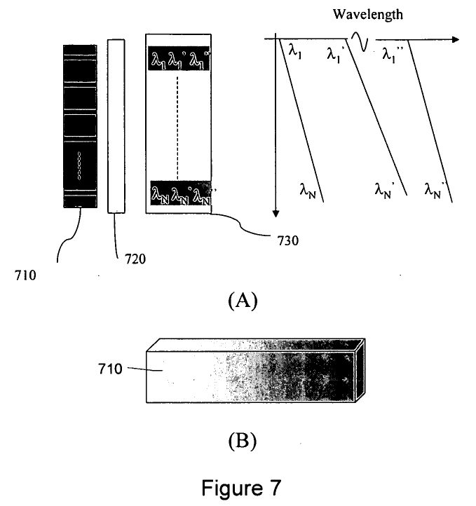

FIGS. 7A and 7B show a schematic for wavelength stabilizing a multimode or single diode bar 700 with collimating optics 710 and a multiplexed VHG 720. In this embodiment, the multiplexed VHG has a spatially continuously varying wavelength across its length. An example of an element having continuous varying wavelength is illustrated in FIG. 7B.

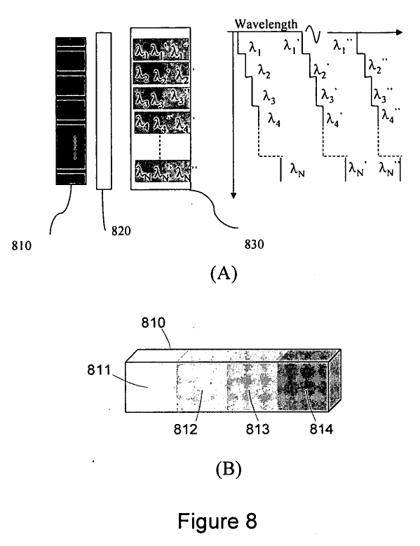

FIGS. 8A and 8B show a schematic for wavelength stabilizing a multimode or single diode bar 800 with collimating optics 810 and the multiplexed VHG 820. In this embodiment, the multiplexed VHG has a spatially stepwise varying wavelength across its length, such as represented in FIG. 8B.

In one embodiment, the continuously varying gratings are made (or recorded) by the interference of two diverging beams. A first diverging beam wave reflects off a planar mirror and a second plane wave reflects off a second planar mirror. The diverging beams are created with a set of cylindrical lenses. Along the location of the volume holographic material, the relative angle between the two interfering beams varies and therefore produces a continuous change in grating period.

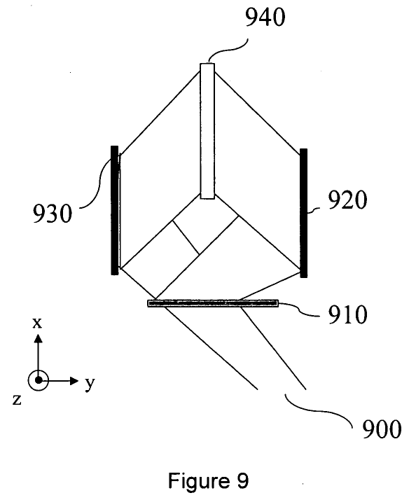

FIG. 9 shows a configuration for recording gratings according to one embodiment of the present invention. The gratings are recorded in reflection geometry. A first beam 900 which is collimated in the z direction and diverging in the xy plane (by an arrangement of cylindrical lenses for example) is split into two beams by beam splitter 910. The two beams are reflected off planar mirrors 920 and 930 and interfere at the position of the volume holographic material 940.

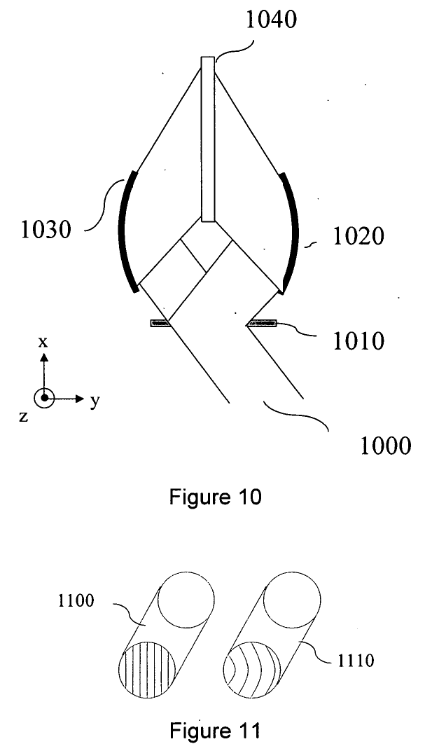

FIG. 10 shows a configuration for recording gratings according to one embodiment of the present invention. The gratings are recorded in reflection geometry. A first beam 1000 which is collimated in all directions is split into two beams by beam splitter 1010.

The two beams are reflected off cylindrical mirrors 1020 and 1030 (with curvature in xy plane) and interfere at the position of the volume holographic material 1040.

The gratings may also be recorded using techniques described in U.S. Pat. No. 6,829,067 entitled “Method and Apparatus for Implementing A Multi-Channel Tunable Filter” and incorporated fully herein.

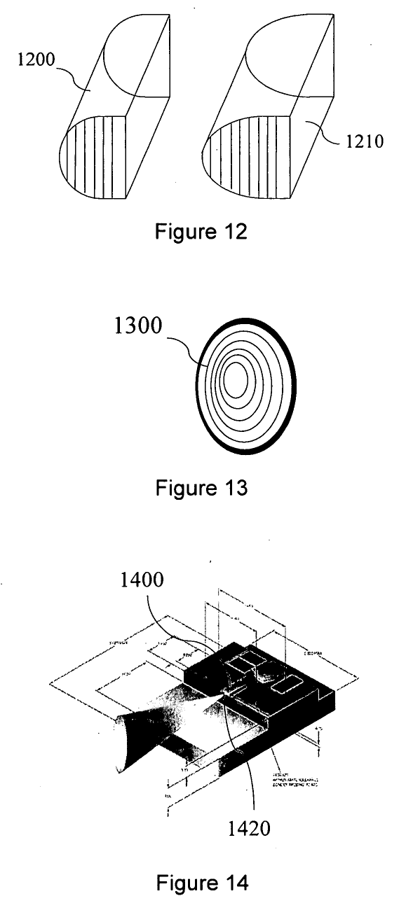

FIG. 11 shows an illustration of a cylindrical lens with integrated VHG. The grating is either planar as in 1100 or curved as in 1110. FIG. 12 shows an illustration of a D-lens 1200 and an aspheric cylindrical lens 1210.

FIG. 13 shows an illustration of a spherical lens 1300. An aspherical lens (not shown) has a non-spherical curvature instead of spherical. FIG. 14 shows an illustration of laser diode. The laser diode chip 1400 has an emission aperture 1420 that is either single mode (typ. 1 μm) or multimode (typ. 100 μm).

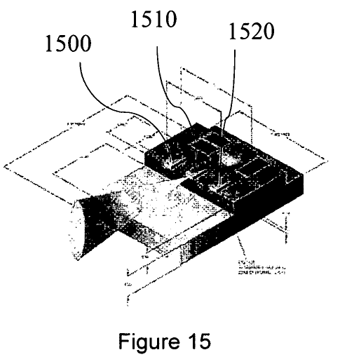

FIG. 15 shows an array of three diode lasers (1500, 1510, 1520) for illustration purposes. Typically there are 19 or more emitters per chip with either single mode or multimode.

Thus, systems, methods and apparatus are described in conjunction with one or more specific embodiments. The invention is defined by the claims and their full scope of equivalents.

1. A refractive element having multiplexed volume holographic gratings with spectrally overlapping individual gratings formed therein, the element receiving the spectral output of an optical source.

2. The element of claim 1 wherein the optical source is a single mode laser diode.

3. The element of claim 1 wherein the optical source is an array of single mode laser diodes.

4. The element of claim 1 wherein the optical source is a multimode mode laser diode.

5. The element of claim 1 wherein the optical source is an array of multimode mode laser diodes.

6. The element of claim 1 wherein the refractive element is a cylindrical lens.

7. The element of claim 1 wherein the multiplexed VHG is a spherical lens.

8. The element of claim 1 wherein the multiplexed VHG is a D-lens.

9. The element of claim 1 wherein the multiplexed VHG is an aspheric lens.

10. The element of claim 1 wherein the multiplexed VHG is an aspheric cylindrical lens.

11. A refractive element having a multiplexed volume holographic grating with spectrally non-overlapping individual gratings formed therein, the element receiving the spectral output of an optical source.

12. The element of claim 11 wherein the optical source is an array of single mode laser diodes.

13. The element of claim 11 wherein the optical source is a multimode mode laser diode.

14. The element of claim 11 wherein the optical source is an array of multimode mode laser diodes.

15. The element of claim 11 wherein the individual wavelengths comprise at least one of 785+/−5 nm, 795+/−5 nm, 808+/−5 nm, 865+/−5 nm, 880+/−5 nm, 905+/−5 nm, 915+/−5 nm, 935+/−5 nm, 969+/−5 nm, 976+/−5 μm, 985+/−5 nm, and 1064+/−5 nm, 1530+/−5 nm

16. The element of claim 11 wherein the refractive element is a cylindrical lens.

17. The element of claim 11 wherein the multiplexed VHG is a spherical lens.

18. The element of claim 11 wherein the multiplexed VHG is a D-lens.

19. The element of claim 11 wherein the multiplexed VHG is an aspheric lens.

20. The element of claim 1 wherein the multiplexed VHG is an aspheric cylindrical lens.
